(19) United States
(12) Patent Application Publication
(10) Pub. No.: US 2012/0330990 A1
(43) Pub. Date: Dec. 27, 2012

(54) EVALUATING QUERY TRANSLATIONS FOR CROSS-LANGUAGE QUERY SUGGESTION

(75) Inventors: Qiliang Chen, Beijing (CN); Weihua Tan, Beijing (CN)

(73) Assignee: GOOGLE INC., Mountain View, CA (US)

(21) Appl. No.: 13/248,775

(22) Filed: Sep. 29, 2011

Related U.S. Application Data
(63) Continuation of application No. PCT/CN2011/076275, filed on Jun. 24, 2011.

(51) Int. Cl. G06F 17/30

(52) U.S. Cl. 707/761; 707/E17.14

(57) ABSTRACT

Computer-implemented methods, systems, computer program products for generating cross-language query suggestions are described. For each query suggestion written in a first natural language, candidate segmentations are generated from the query suggestion, and candidate translations are generated from each candidate segmentation. The candidate translations are evaluated based on a measure of segmentation quality associated with the respective candidate segmentation from which each candidate translation is derived, and a frequency of occurrence of the candidate translation in a target language query log. The measure of segmentation quality associated with each candidate segmentation is further based on a frequency of occurrence of the candidate segmentation in a source language query log. A candidate translation is provided as a cross-language query suggestion for the primary language query suggestion based on the result of the evaluation.

### TECHNICAL FIELD

This specification relates to computer-implemented query suggestion services, and more particularly, to providing cross-language query suggestions.

### BACKGROUND

Search engines can offer input suggestions (e.g., query suggestions) that correspond to a user's query input. The input suggestions include query alternatives to a user-submitted search query and/or suggestions (e.g., auto-completions) that match a partial query input that the user has entered. In order to provide input suggestions that are likely to be relevant to the user's interest and present information needs, search engines evaluate input suggestion candidates based on various criteria before selecting particular input suggestion candidates for presentation to the user. Internet content related to the same topic or information often exists in different natural languages and/or writing systems on the World Wide Web. A multi-lingual user can try to formulate corresponding queries in different languages and/or writing systems and provide the queries to a search engine to locate relevant content in the different languages and/or writing systems. However, formulating an effective search query in a non-native language or writing system can be challenging for many multi-lingual users, even with the help of a multi-lingual dictionary. A search engine capable of providing cross-language input suggestions (e.g., cross-language query suggestions) can help alleviate this difficulty. Technologies for improving the quality and effectiveness of machine-generated cross-language query suggestions are needed.

### SUMMARY

This specification describes technologies relating to generation of cross-language query suggestions.

In general, one aspect of the subject matter described in this specification can be embodied in methods that include the actions of: receiving a query written in a first language, the query being a primary-language query suggestion generated based on a user input submitted to a search engine; obtaining one or more unique candidate segmentations of the query in the first language, each unique candidate segmentation consisting of a respective sequence of segments resulted from segmenting the query in the first language; for each of the one or more unique candidate segmentations, determining a respective set of one or more candidate translations in a second language by translating the respective sequence of segments of the candidate segmentation; for each candidate translation of each of the one or more unique candidate segmentations: (1) determining a respective segmentation quality for the unique candidate segmentation based at least in part on how many stop words have been removed from the respective sequence of segments of the unique candidate segmentation and a respective first frequency of occurrence of the unique candidate segmentation in a first query log as a complete query written in the first language; and (2) determining a respective score for the candidate translation based at least on the respective segmentation quality determined for the unique candidate segmentation and a respective second frequency of occurrence of the candidate translation in a second query log as a complete query written in the second language; and providing at least one of the candidate translations as a cross-language query suggestion for the query based on respective scores of the candidate translations.

In general, one aspect of the subject matter described in this specification can be embodied in methods that include the actions of: receiving a query written in a first language; obtaining one or more unique candidate segmentations of the query in the first language, each unique candidate segmentation consisting of a respective sequence of segments resulted from segmenting the query in the first language; for each of the one or more unique candidate segmentations: (1) determining a respective measure of segmentation quality for the unique candidate segmentation; and (2) obtaining a respective set of one or more candidate translations in a second language by translating the respective sequence of segments of the candidate segmentation; for each candidate translation of each of the one or more unique candidate segmentations: (1) determining a first frequency of occurrence of the candidate translation in a first query log as a complete query written in the second language; and (2) determining a respective score for the candidate translation based at least on the first frequency of occurrence of the candidate translation in the first query log as a complete query written in the second language, and the measure of segmentation quality for the candidate segmentation; and providing at least one of the candidate translations as a cross-language query suggestion for the query based on respective scores of the candidate translations.

Other embodiments of these aspects include corresponding computer systems, apparatus, and computer programs recorded on one or more computer storage devices, each configured to perform the actions of the methods. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

These and other embodiments can optionally include one or more of the following features.

In some implementations, the action of obtaining the one or more unique candidate segmentations of the query in the first language further includes obtaining at least one candidate segmentation that is a partition of the query in the first language. In some implementations, the action of obtaining the one or more unique candidate segmentations of the query in the first language further includes obtaining at least one candidate segmentation that has one or more stop words removed from the candidate segmentation.

In some implementations, for each of the one or more unique candidate segmentations, the action of determining the respective measure of segmentation quality for the unique candidate segmentation further includes determining the respective measure of segmentation quality based at least in part on how many stop words have been removed from the respective sequence of segments of the candidate segmentation.

In some implementations, for each of the one or more unique candidate segmentations, the action of determining the respective measure of segmentation quality for the unique candidate segmentation further includes: determining a respective second frequency of occurrence for the candidate segmentation in a second query log as a complete query written in the first language; and determining the respective measure of segmentation quality based at least in part on the respective second frequency of occurrence of the candidate segmentation in the second query log as a complete query written in the first language.

Particular embodiments of the subject matter described in this specification can be implemented so as to realize one or more of the following advantages.

With particular embodiments of the techniques described in this specification, a user who enters a query input in a first language (e.g., the user's native language) may automatically be provided with cross-language query suggestions (i.e., query suggestions in a second language). The cross-language query suggestions can be provided along with corresponding query suggestions in the first language which are provided based on the user's initial query input. Each cross-language query suggestion has been evaluated by the search engine and determined to be not only an appropriate or precise translation of a corresponding query suggestions in the first language (e.g., a primary language query suggestion), but also an effective search query for retrieving cross-language content related to the same topic or information as that targeted by the primary language query suggestion. By selecting a cross-language query suggestion, the user can retrieve content in the second language that may be more relevant or comprehensive than the content available in the first language. In addition, a search task can be implemented in an efficient manner and provide a good user experience. Not only can the need for manually translating a primary-language query suggestion be avoided, the effectiveness of a cross-language query suggestion generated based on machine translation can be improved as well.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example of data flow in an example system that generates query suggestions in different natural languages.

FIG. 2 is a screenshot illustrating an example web page presenting a group of first query suggestions in a first language and a group of second query suggestions in a different, second language.

FIG. 3 is a block diagram illustrating an example of a translation subsystem that provides a translation of a query (e.g., a primary language query suggestion) as a cross-language query suggestion based on query translation evaluations performed by a refinement module of the translation subsystem.

FIG. 4 is a block diagram illustrating an example of a refinement module in the translation subsystem as illustrated in FIG. 3.

FIG. 5 is a flow diagram illustrating an example process for evaluating query translations as potential cross-language query suggestions and providing a query translation as a cross-language query suggestion based on the evaluation.

Like reference numbers and designations in the various drawings indicate like elements.

### DETAILED DESCRIPTION

A search engine can provide primary language query suggestions in response to a query input entered by a user. The primary language query suggestions are query suggestions written in the language or writing system of the user's original query input. The search engine can also provide a cross-language query suggestion for each primary language query suggestion, where the cross-language query suggestion is a query written in a secondary language or writing system different from that of the primary language query suggestion. When providing a cross-language query suggestion, a search engine evaluates a number of candidate translations for the primary language query suggestion, and selects one that is both an accurate translation of the primary language query suggestion, but also are likely to be an effective search query for retrieving cross-language content that is on the same topic as the primary language content targeted by the primary language search query.

As described in this specification, the search engine can rely on a number of factors including a segmentation quality of each candidate segmentation generated from the primary language query suggestion as well as a translation quality of each candidate translation generated from each candidate segmentation to evaluate the candidate translations as a potential cross-language query suggestion for the primary language query suggestion. Among other factors, the segmentation quality of a candidate segmentation can be based on a query frequency (or query count) of a user-submitted search query that is found in a primary language query log (also called “source language query log”) and that matches (e.g., is identical to, or is identical to but for one or more stop words) the candidate segmentation. Similarly, the translation quality of a candidate translation of the candidate segmentation can be based on a query frequency (or query count) of a user-submitted search query that is found in the cross-language query log (also called “target language query log”) and that matches the candidate translation.

The query frequencies can help the search engine assess not only whether a particular translation conforms to custom language usage in the target language, but also whether the particular translation conforms with the way search queries are formulated by people who are native speakers of the target language.

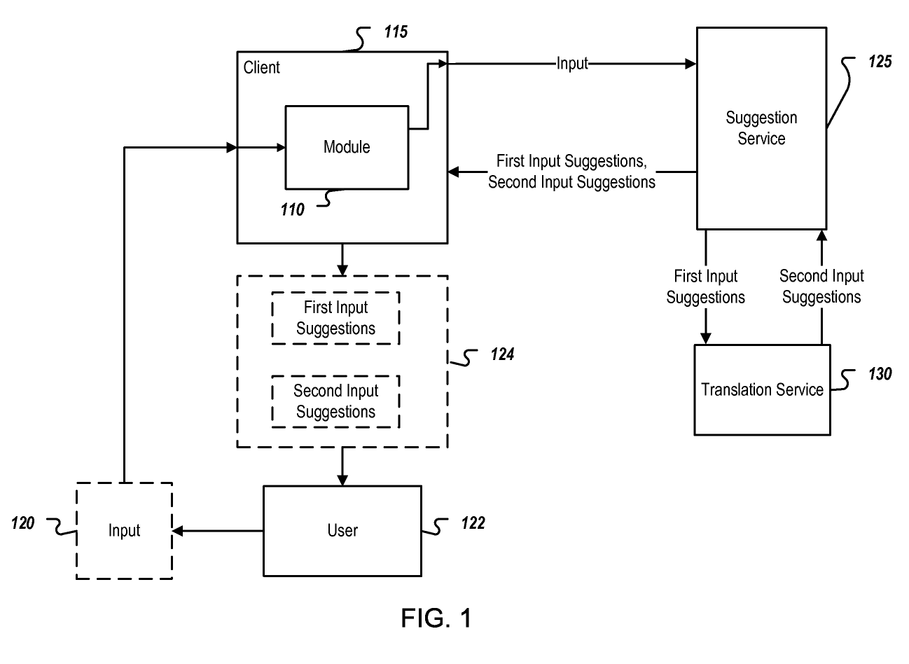

FIG. 1 is a block diagram illustrating an example of data flow in an example system that generates input suggestions (e.g., query suggestions) in different forms of natural language representations. A module 110, e.g., a JavaScript script, running on a client device 115 monitors input 120 received in a search engine query input field from a user 122. The input 120 is written in a first form of natural language representation, e.g., as a term or phrase written in English words, in Chinese characters, in Pinyin, in Hiragana, or in Katakana.

More generally, the first form is a first writing system used for a first natural language. As an example, the first writing system can be Hanzi (represented using Hanzi characters) and used for the first natural language Chinese. Alternatively, the first writing system can be a phonetic spelling system (e.g., represented using letters of the English alphabet) and used for the first natural language English. Some writing systems can be used to represent multiple natural languages. Such a writing system can be used with different sound systems (e.g., systems of phonemes) to encode meaning in multiple natural languages. As an example, the first writing system can be a phonetic spelling system (e.g., represented using characters of a standard or extended Latin alphabet) and used for the natural language English, the natural language German, or the natural language Chinese (e.g., as used in Romanized Chinese or Pinyin).

In some implementations, the module 110 is plug-in software that is installed in a web browser running on the client device 115. In some alternative implementations, the module 110 is installed on an intermediate server that receives the input 120, e.g., from the client device 115. The module 110 receives the input 120 and automatically sends the input 120 to a suggestion service module 125, as the input 120 is received. In some implementations, the suggestion service module 125 is software running on a server (e.g., a server distinct from the intermediate server) that receives a textual input, e.g., a user-submitted search query, and returns alternatives to the textual input, e.g., query suggestions.

The suggestion service module 125 determines a set of first input suggestions in the first form (e.g., primary language query suggestions), and sends one or more of the first input suggestions to a translation service module 130. The first input suggestions are alternatives to the input 120, e.g., expansions and completions. For example, if the input 120 include letters or words written in English, the first input suggestions can include query suggestions written in English that are either related alternative queries or auto-completed queries that match the input 120.

In some implementations, the translation service module 130 is software running on a server that receives textual input (e.g., a query suggestion in the first form) and returns alternatives to the textual input that are represented in different writing systems or natural languages, e.g. translations and transliterations. The translation service 130 can be used to identifies representations of the first input suggestions in a different, second form.

The different, second form can be a different writing system from and for a same natural language as the first form. In other words, a representation of a first input suggestion in the different, second form can be a transliteration. As an example, a first input suggestion can be a Hanzi character “ [symbol] ” (e.g., “car” in English) and an associated second input suggestion can be “chē” (e.g., a Romanized Chinese representation of “ [symbol] ”).

The different, second form can also be a different writing system and/or for a different natural language from the first form. In other words, a representation of a first input suggestion in the different, second form can be a translation in a different writing system. As an example, a first input suggestion can be an English word “car” and an associated second input suggestion can be “ [symbol] ” (e.g., a Hanzi character meaning “car”).

Furthermore, the different, second form can be a same writing system as and for a different natural language from the first form. In other words, a representation of a first input suggestion in the different, second form is a translation in a same writing system. As an example, a first input suggestion can be an English word “car” and an associated second input suggestion can be “chē” (e.g., a Romanized Chinese representation of a Hanzi character “ [symbol] ” that can mean “car”).

In some implementations, the user 122 specifies the different, second form by a setting in user preferences. In some implementations, the module 110 automatically selects the different, second form from frequently used language pairs that include the first form.

The representations of the first input suggestions in a different, second form are identified as being second input suggestions (e.g., cross-language query suggestions). The translation service module 130 returns the second input suggestions to the suggestion service module 125. The translation service module 130 also returns data identifying associations between the first input suggestions and the second input suggestions. An association indicates that a particular second input suggestion is a representation in a second form of a particular first input suggestion in a first form.

The module 110 receives the first input suggestions, second input suggestions, and associations from the suggestion service 125. The first input suggestions and the second input suggestions are all distinct from the input 120.

The module 110 can present the first input suggestions (e.g., primary language query suggestions) and second input suggestions (e.g., cross-language query suggestions) to the user 122 in real time, i.e., as the user 122 is typing characters in the search engine query input field. For example, the module 110 can present a first group of first input suggestions and second input suggestions associated with a first character typed by the user 122, and present a second group of first input suggestions and second input suggestions associated with a sequence of the first character and a second character in response to the user 122 typing the second character in the sequence, and so on.

FIG. 1 represents an overall example data flow in a system that provides both primary language and cross-language query suggestions. Multiple candidate translations can be generated (e.g., using a machine translation subsystem) for each query suggestion in the first form (e.g., each primary language query suggestion), and not all candidate translations are effective queries that target content on the same topic as the query suggestion in the first form. As described in this specification, the translation service module 130 evaluates the multiple candidate translations as potential cross-language query suggestions, and based on the evaluation, identifies a candidate translation that is both an accurate translation of the query suggestion in the first form, and an effective query for retrieving cross-language content on the same topic as that that targeted by the query suggestion in the first form. The identified candidate translation is then provided to the user through the suggestion service module 125.

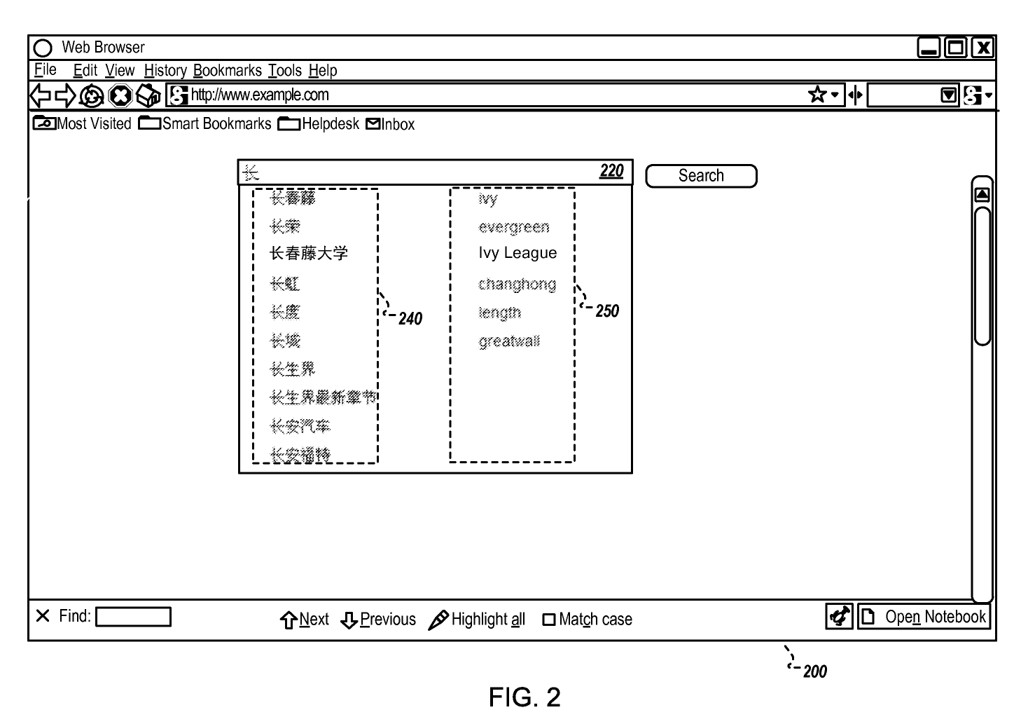

FIG. 2 is a screenshot illustrating an example of a web page 200 presenting a group of first input suggestions in a first form (e.g., primary language query suggestions) and a group of second input suggestions in a different, second form (e.g., cross-language query suggestions). The web page includes a search query input field 220. The search query input field 220 includes a user-submitted query input “ [symbol] ”, e.g., “cháng” in Romanized Chinese meaning “long” in English, or “zh\check{a}ng” in Romanized Chinese meaning “elder” in English.

In response to the entry of the query input, the user's device (e.g., by the module 110 in FIG. 1) requests input suggestions from a suggestion service module (e.g., the suggestion service module 125 in FIG. 1). After the client device receives first input suggestions, the client device provides the first input suggestions for display in an interface element of the web browser showing the web page 200. In the example of FIG. 2, the interface element is a drop-down menu showing first input suggestions that are expansions of the Hanzi character “ [symbol] ”, e.g., “ [symbol] ” meaning “ivy” in English, and “ [symbol] ” meaning “Evergreen”, an airline, in English, and so on.

In the example of FIG. 2, the client device is further configured to request second input suggestions that correspond to the first input suggestions from the suggestion service module. After receiving the second input suggestions, the client device provides the first input suggestions and the second input suggestions for display in parallel in distinct portions of the webpage 200. For example, the first input suggestions are provided in a first portion 240, and the second input suggestions are provided in a second portion 250, of a same interface element, e.g., a drop-down menu.

In the example of FIG. 2, the association between each first input suggestion and a corresponding second input suggestion is also represented visually by the horizontal alignment of the first input suggestion and the corresponding second input suggestion. For example, a first input suggestion “ [symbol] ” is horizontally aligned with a second input suggestion “ivy”, which is a translation of “ [symbol] ”. A first input suggestion “ [symbol] ” is horizontally aligned with a second input suggestion “Evergreen”, which is a translation of “ [symbol] ”. A first input suggestion “ [symbol] ” is horizontally aligned with a second input suggestion “ivy league”, which is a translation of “ [symbol] [symbol] ”.

One or more first input suggestions may not be associated with any appropriate second input suggestions. In the example of FIG. 2, first input suggestions that are not associated with any second input suggestions are not aligned with any second input suggestions. As an example, a first input suggestion “ [symbol] ” is not aligned with a second input suggestion. The entire sequence of Hanzi characters “ [symbol] ” does not have a meaningful representation in English. Note, however, that separately, “ [symbol] ” can mean “Chang'an” (capital of China during the Tang Dynasty) in English, and “ [symbol] ” can mean “car” in English.

When a user selects one of the input suggestions from the user interface element, the module 110 sends the selection in a request for a search, and a web browser instance is redirected to a web page displaying search results generated by the search engine for the selected input suggestion.

As shown in the example of FIG. 2, some first input suggestions have translations that are fairly definite in the second form. For example, the literal translation of “ [symbol] ” in English is “ivy”. Both “ [symbol] ” and “ivy”, when used as search queries, are equally effective in searching content related to the same type of evergreen plant in Chinese and English, respectively. In contrast, “ [symbol] ” can be translated as “ivy university”, “ivy college”, “ivy league”, “ivy schools”. Even though “ivy university”, “ivy college”, and “ivy schools” are more literal translations of the Chinese words “ [symbol] ” and “ [symbol] ”, “ivy league” is a better choice as a second input suggestion. The reason may be that “ivy league” has been more frequently entered as a search query in English by users who are native speakers of English, and is more effective at retrieving English content on the same topic as that targeted by the Chinese query “ [symbol] [symbol] ” than “ivy university”, “ivy college”, and “ivy schools” are.

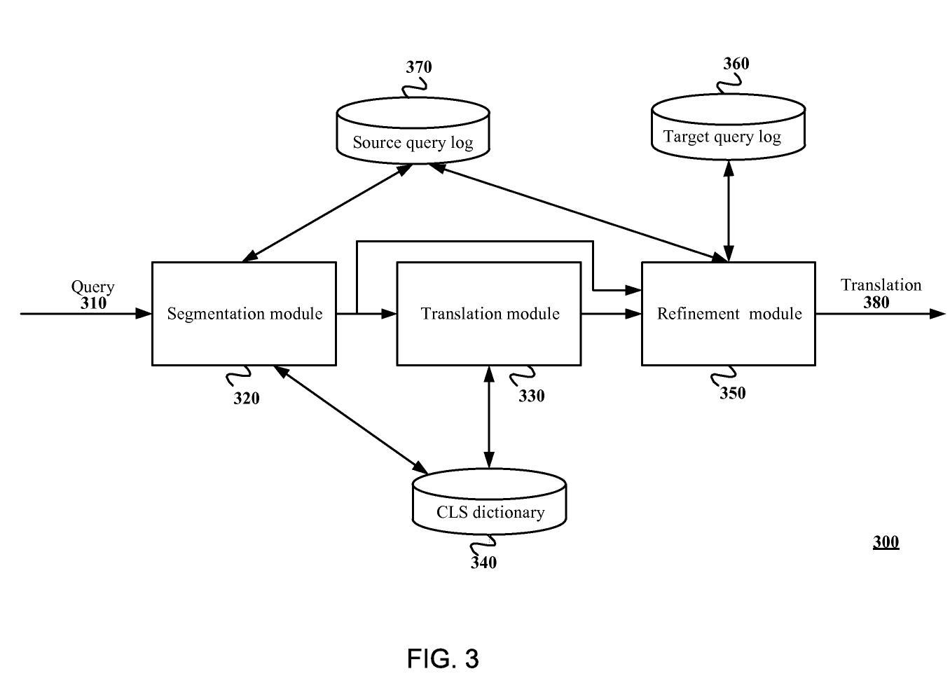

FIG. 3 illustrates an example of a subsystem 300 that provides a translation 380 of a query 310 as a cross-language query suggestion, based on evaluations of multiple candidate query translations of the query 310. The query 310 can be one of the first input suggestions provided by the suggestion service module 125 to the translation service module 130 in FIG. 1. The subsystem 300 can serve as the translation service module 130 in FIG. 1.

As illustrated in FIG. 3, the example subsystem 300 includes a segmentation module 320, a translation module 330, a Cross-Language Suggestion (“CLS” hereinafter) dictionary 340, a refinement module 350, a target language query log 360, and a source language query log 370.

In the modules and elements as included in the subsystem 300, the segmentation module 320 is for generating one or more unique candidate segmentations from the query 310 written in a first form (e.g., a first natural language and associated writing system). Each candidate segmentation of the query 310 consists a unique sequence of segments obtained by segmenting or dividing the input query 310 in a particular manner, with or without stop words removal. Each segment includes one or more constituent n-grams (e.g., words in an English or German query or characters in a Chinese or Korean query) of the input query 310. If the segments resulted from a particular manner of segmenting or dividing the query 310 include one or more stop words, the stop words can be removed, such that only segments that are not stop words remain in the resulting segmentation. If no stop words are removed from a segmentation, the segmentation is also a so-called “partition” of the query 310. A partition of the query 310 includes all segments resulted from a particular manner of segmenting or dividing the input query 310. For each input query, one or more candidate segmentations can be generated by the segmentation module 320. Depending on the algorithms used by the segmentation module 320, some candidate segmentations are of better quality than other candidate segmentations. A higher quality segmentation will lead to a better chance of producing a correct translation of the input query 310, when the segments of the segmentation are translated by the translation module 330.

The translation module 330 is for translating the respective sequence of segments of each of the one or more unique candidate segmentations into a respective set of one or more candidate translations in a second form (e.g., a second natural language and associated writing system). Since one or more segments of a candidate segmentation can have more than one translation in the second form, each candidate segmentation can also have more than one translation in the second form.

The translation module 330 can use various machine translation techniques to generate the candidate translations for the input query 310 based on each candidate segmentation of the input query 310. For example, the translation module can utilize an online machine translation service or a multi-lingual dictionary. In some implementations, the translation module 320 can utilize a specialized dictionary (e.g., a CLS dictionary 340) for translating the input query 310 based on the candidate segmentations of the input query 310. The CLS dictionary 340 includes a large number of entries that have been created based on at least one of another dictionary (e.g., an online dictionary), online release information, and semi-structured web pages that provide translation pairs consisting of words or phrases in the first language and their corresponding translations in the second language.

After the translation module 330 has generated the candidate translations for the input query 310 based on each of the candidate segmentations, the translation module 330 can provide the candidate translations to the refinement module 350. The refinement module 350 is for evaluating the candidate translations as potential second input suggestions (e.g., cross-language query suggestions). The refinement module 350 can identify one or more (e.g., one) candidate translations that are both accurate translations of the input query 310, but also effective search queries for searching cross-language content on the same topic as the input query 310, based on the result of the valuation.

When evaluating the candidate translations produced by the translation module 320, the refinement module 350 can rely on information stored in one or more query logs. The query logs stores queries previously submitted by users to the search engine. In some implementations, the search engine may provide search interfaces for different locales or geographic regions using different domain names (e.g., www.search.com.uk for United Kingdom; www.search.com.hk for Hong Kong, www.search.com.fr for France, etc.). Therefore, the query logs can be divides by geographic regions or countries, and/or languages that are commonly associated with the different geographic regions or countries.

As shown in FIG. 3, a source language query log 370 stores user queries that are written in the first form (e.g., the first language and associated writing system), and the target language query log 360 stores user queries that are written in the second form (e.g., the second language and associated writing system). In some implementations, each query log also includes data representing the respective query frequency for each user-submitted search query in the query log. The query frequency of a user-submitted search query can be a query count of the search query submitted a given time period, or a total query count of the search query that has accumulated in the query log. In some implementations, the query frequency may be adjusted by a freshness factor, and a search query that has recently surfaced in the query log but has seen a sharp rise in query count in a short period of time can be given a boost (e.g., a multiplier greater than unity) in its query frequency.

As described in more details in the example below, the segmentation module 320 can access the information stored in the query logs for generating the segmentations of a query 310. The refinement module 350 can access the information stored in the query logs for evaluating the segmentation quality, the translation quality, as well as the effectiveness of the candidate translations as a cross-language query suggestion for the input query 310.

After the refinement module 350 finishes evaluating the different candidate translations of the input query 310, the refinement module 350 can identify one of the candidate query translations (e.g., translation 380) as the most appropriate query translation for the input query 310, and provide the identified candidate query translation 380 as a cross-language query suggestion back to the user through the suggestion service module (e.g., the suggestion service module 125 in FIG. 1). The cross-language query suggestion can then be presented along with the input query 310 as a pair of query suggestions in the list of first query suggestions and second query suggestions.

In some implementations, the identified pair of query suggestions can be stored in an index, where each entry in the index includes a pair of query suggestions that are translations of each other, and are user-submitted native language queries effective in retrieving content in their respective languages that is on the same topic. After such an index is developed, a cross-language query suggestion for a first language input suggestion can be looked up in the index, rather than derived on the fly.

For illustrative purposes, operations of the subsystem 300 will be discussed in detail hereinafter under an exemplary scenario in which the first language is Chinese, the second language is English, and the input query 310 is a sequence of Chinese characters “ [symbol] ”, which means “travel destination” in English.

Upon receiving the input query 310 “ [symbol] ” (e.g., where “ [symbol] [symbol] ” is a primary language query suggestion generated in response to a query input “ [symbol] ” entered by a user through a search engine web page), the segmentation module 320 generates one or more unique candidate segmentations by dividing the input query 310 “ [symbol] ” into a sequence of segments. Depending on the locations of the dividing points in the input query “ [symbol] ”, different candidate segmentations can result.

In some implementations, the candidate segmentations can be obtained by enumerating all possible combinations of consecutive characters of the input query 310. For example, “ [symbol] ” can be segmented into the following unique sequences of segments: (1) “ [symbol] ”; (2) “ [symbol] ”; (3) “ [symbol] ”; (4) “ [symbol] ”; (5“ [symbol] ”; (6) “ [symbol] ”; (7) “ [symbol] ”; (8) “ [symbol] ”; (9) “ [symbol] ”; (10) “ [symbol] [symbol] ”; (11) “ [symbol] ”; (12) “ [symbol] ”; (13) “ [symbol] ”, and so on.

In some implementations, the segmentation module 320 can also look to the CLS dictionary 340 to determine if a particular segmentation would produce segments that cannot be found in the CLS dictionary 340. If a particular manner of segmenting the input query 310 would produce segments (other than segments that are stop words) not found in the CLS dictionary 340, then the segmentation module 320 may determine that such manner of segmenting the input query 310 would result an incorrect segmentation, and avoid generating a candidate segmentation based on this way of segmenting the input query 310. For example, if the segment “ [symbol] ” cannot be found in the CLS dictionary 340, the segmentation module 320 can eliminate the segmentations “ [symbol] ” as a candidate segmentation for the input query “ [symbol] [symbol] ”.

In some implementations, the segmentation module 320 also looks to the query log associated with the Chinese language (e.g., the source language query log 370). If a particular manner of segmenting the input query would produce segments not found in the query log associated with the Chinese language, then the segmentation module 320 can determine that such manner of segmenting the input query 310 would result an incorrect segmentation, and avoid generating a candidate segmentation based on this way of segmenting the input query. For example, if the segment “ [symbol] ” cannot be found in the source language query log 370, the segmentation module 320 can eliminate the segmentation “ [symbol] ” as a candidate segmentation for the input query “ [symbol] ”.

In some implementations, the segmentation module 320 can also look to the query log associated with the Chinese language (e.g., the source language query log 370) to see if a particular segmentation exists in the query log. If a particular segmentation exists in the query log of the Chinese language, it is highly likely that this particular segmentation is a correct segmentation of the input query 310 in Chinese. For example, if “ [symbol] ” has been entered as a search query by many users and logged in the source language query log 370, the segmentation module 320 can determine that “ [symbol] ” is a high quality candidate segmentation of the input query “ [symbol] ”.

In some implementations, if a particular segmentation is found in the query log of the first language as a user-submitted search query, the segmentation module 320 can record the query frequency of the user-submitted search query in association with the particular candidate segmentation, so that the refinement module 350 can use the query frequency to assess the segmentation quality of the particular segmentation. A higher query frequency or query count indicates a higher quality segmentation quality. In some implementations, the query frequency can be an adjusted query frequency based on the freshness of the user-submitted search query.

Suppose that after eliminating segmentations that include segments (other than segments that are stop words) not found in the CLS dictionary 340, the segmentation module 340 produces the following unique candidate segmentations: (1) “ [symbol] ”; (2) “ [symbol] ”; and (3) “ [symbol] ”.

For each of the candidate segmentations, the segmentation module 320 determines whether the candidate segmentation includes any stop words. In some implementations, a predetermined stop word list can be consulted to determine whether a candidate segmentation includes any segment that is a stop word. Examples of stop words in English include: “the”, “a”, “to”, “of”, and so on. Examples of stop words in Chinese include: “ [symbol] ”, “ [symbol] ”, “ [symbol] ”, and so on. In some implementations, the segmentation module 320 can remove the segments that are identified as stop words from each candidate segmentation such that the candidate segmentation only includes segments that are words found in the CLS dictionary.

For example, in the segmentation (1), after removal of the stop word “ [symbol] ”, the candidate segmentation (1) becomes “ [symbol] ”. The CLS dictionary 340 contains the translation pairs, e.g., “ [symbol] : travel”, “ [symbol] : trip”, “ [symbol] : eye”, “ [symbol] : catalogue”, “ [symbol] : earth”, and “ [symbol] : ground”. In other words, only the segments “ [symbol] ”, “ [symbol] ”, and “ [symbol] ” will be translated later by the translation module 330.

In some implementations, the segmentation module 340 can record the number of stop words that are removed from a candidate segmentation, such that the number can be used by the refinement module 350 as a factor in determining the quality of the candidate segmentation and the quality of the candidate translations resulted from translating the segments of the segmentation. In general, when fewer stop words are removed, the resulting segmentation and associated candidate translations are considered to be of better quality.

Similarly, in the segmentation (2) “ [symbol] ”, no stop words are identified in the segments. Thus, the candidate segmentation is still “ [symbol] [symbol] ”. Since no stop words are removed, this candidate segmentation includes all characters of the input query, and is thus a partition of the input query 310. All things being equal, a partition is considered to be of a higher segmentation quality than a candidate segmentation that has one or more stop words removed. The CLS dictionary 340 contains translation pairs, e.g., “ [symbol] : travel,” “ [symbol] : trip”, “ [symbol] : aim,” “ [symbol] : goal”, “ [symbol] : purpose”, “ [symbol] : earth”, and “ [symbol] : ground”. Thus, the segments “ [symbol] ”, “ [symbol] ”, and “ [symbol] ” will be translated by the translation module 30 to generate the candidate translations of the input query 310 based on this candidate segmentation.

In segmentation (3), the segments “ [symbol] ” and “ [symbol] ” are both found in the CLS dictionary 340 and the segmentation (3) does not contain any segment that is a stop word. Thus, the segmentation (3) is also a partition of the input query 310. The CLS dictionary 340 contains translation pairs with respect to these two segments, e.g., “ [symbol] : travel,” “ [symbol] : trip,” and “ [symbol] : destination.” Thus, the segments “ [symbol] ” and “ [symbol] ” will be used by the translation module 330 to generate the candidate translations of the input query 310 based on this candidate segmentation.

In some implementations, the segmentation module 340 can also use the information in the query log associated with the first language (e.g., the source language query log 370) to determine the segmentation quality. For example, when users perform searches using a search engine, sometime, some users will enter search queries in a form that already shows the proper segmentations, while others will enter search queries that are not segmented. For example, for the search query “ [symbol] [symbol] ”, some user may insert a white space between “ [symbol] ” and “ [symbol] ” when submitting the query to the search engine. Thus, the candidate segmentation “ [symbol] , [symbol] ” would be found in the source language query log. If the query “ [symbol] [symbol] ” has a high query frequency, the candidate segmentation “ [symbol] ” can be given a high segmentation quality score.

In some implementations, the segmentation module 320 does not score the candidate segmentation, and merely records the query frequency in association with the candidate segmentation, such that the query frequency can be used by the refinement module to determine the segmentation quality of the candidate segmentation. In some implementations, the query frequency is given a greater weight in the scoring of the segmentation quality than the number of stop words removed from the candidate segmentation.

As another example, another query that is likely to be found in the query log with a high query frequency is “ [symbol] ” (means “travel purpose” in English). This particular segmentation can be found in the candidate segmentation “ [symbol] [symbol] ” for example. In some implementations, such partial match can be utilized to determine that the candidate segmentation “ [symbol] ” is at least partially correct. In some implementations, since “ [symbol] ” is sometimes used in a similar manner as “ [symbol] ”, the character “ [symbol] ” can be considered to be a stop word and removed from the candidate segmentation. Thus, in such implementations, “ [symbol] ” can be considered a correct segmentation according to the data from the source language query log 370. But the overall segmentation quality of the candidate segmentation “ [symbol] , [symbol] ” is scored lower than the candidate segmentation “ [symbol] ”, since the former has one stop word removed, while the latter has no stop words removed.

Based on the above operations, the segmentation module 320 segments the query 310 “ [symbol] ” into three unique candidate segmentations (1) “ [symbol] ”; (2) “ [symbol] ”; and (3) “ [symbol] ”, and transmits them to the translation module 330 for translation and to the refinement module 350 for evaluation.

Upon receipt of three unique candidate segmentations, the translation module 330 translates them into various translations in English based on the translation pairs contained in the CLS dictionary 340. In some implementations, the translation is based on direct translation of each segment in the candidate segmentation, irrespective of whether the resulting translations comply with conventional usage or make overall sense. For example, with respect to the candidate segmentation “ [symbol] ” the translation module 330 may translate it into candidate translations including “trip eye earth” “trip catalogue earth” “travel eye ground” and “travel catalogue ground” etc., even though some or all of these resulting translations do not have a sensible meaning or do not appear in custom usage in everyday speaking or writing.

Although in some implementations, the translation module 330 can use conventional translation techniques to try to derive a sensible translation, e.g., by omitting segments whose meanings are incompatible with those of the other segments, in other implementations, it is preferable that the candidate translations strictly correspond to the segments of the candidate segmentation. The reason for keeping the translations that are not in perfect compliance of conventional usage in everyday speaking or writing is that search queries submitted to a search engine are often structured differently from the way the people generally speak or write to another person. Thus, a candidate translation that departs somewhat from custom usage in daily speaking or writing can nonetheless be an effect search query.

In some implementations, when the translation module 330 translates the candidate segmentations, the resulting translation may include stop words in the second language. For example, when a conventional machine translation service is used to translate the candidate segmentation “ [symbol] ”, the resulting translation can be a phrase that conforms to conventional usage, such as “the purpose of travel”. The translation includes two stop words “the” and “of”, and the order of the two words “purpose” and “travel” are reversed relative to the order of the two words “ [symbol] ” and “ [symbol] ”. In some implementations, the translation module can remove the stop words from the candidate translation and reverse the order of the terms in the translation, such that the candidate translation does not include any stop words, and the order of the terms correspond to the order of the terms in the candidate segmentation. In some implementations, the order of the words is ignored.

For example, with respect to the candidate segmentation “ [symbol] [symbol] ,” the translation module 330 may translate it into “the purpose of travel” which results in the translation “travel purpose” after stop words “the” and “of” are removed and word order is reversed. One reason for removing the stop words and reversing or ignoring the order of the terms is that when evaluating the candidate translation against queries found in the query log associated with the second language (e.g., the target language query log 360), the queries in the query log already have stop words removed.

Upon completion of the translation of the candidate segmentations, the resulting one or more candidate translations are forwarded collectively to the refinement module 350 for evaluation. The evaluation is based at least on the quality of the segmentation from which a candidate translation is derived, and the quality of the translation as a search query in the second language. As set forth briefly earlier in this specification, segmentation quality of a candidate segmentation can be determined based on the number of stop words that were removed from the candidate segmentation. All things being equal, a larger number of stop words removed corresponds to a lower segmentation quality score. In addition or alternatively, if a candidate segmentation can be found in the query log of the first language (e.g., the source language query log 370), the candidate segmentation can be given a boost in its segmentation quality score. The amount of boost given to the segmentation quality score can be based on the query frequency associated with the query that matches the particular candidate segmentation. A greater boost can be given for a higher query frequency. In some implementations, the match is required to be a complete match (i.e., the segmentation appears as a complete query in the query log with no modification). In some implementations, a partial match may be considered a match as well.

In some implementations, quality of a candidate translation as a search query can be determined based on whether the candidate translation can be found in the query log associated with the second language (e.g., the target language query log 360), and if so, based on the query frequency associated with the matching query in the query log. A higher query frequency can be associated with a higher translation quality for the candidate translation. In some implementations, a complete match is required. In some implementations, a partial match may be considered as well.

In some implementations, the refinement module 350 can obtain the data (e.g., query frequency, number of stop words removed, degree of match with queries in the query logs) used to score the candidate translations from the segmentation module 320 and the translation module 330. In some implementations, the refinement module 350 can obtain some of the data directly from the query logs 360 and 370.

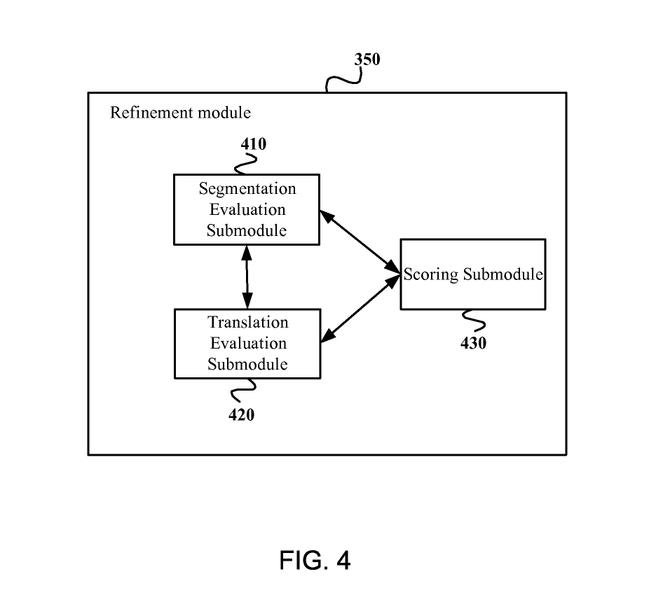

FIG. 4 is a block diagram of an example refinement module 350 as shown in FIG. 3. As illustrated in FIG. 4, the refinement module 350 includes a segmentation evaluation submodule 410, a translation evaluation submodule 420, and a scoring submodule 430. In various implementations, the submodules of the refinement module 350 may communicate and interact with one another within the refinement module 350 and/or with other modules outside of the refinement module 350.

Continue with the specific example “ [symbol] ” used in FIG. 3, for each candidate translation of each of the one or more unique candidate segmentations, the translation evaluation submodule 420 can determine a frequency of occurrence of the candidate translation in the target language query log (e.g., the English query log) as a complete query written in English by retrieving data from the target language query log (e.g., the query log 360 in FIG. 3). For example, with respect to the candidate translation “travel eye ground” for the candidate segmentation “ [symbol] ”, even if the translation exists in the target language query log, the query frequency associated with the query “travel eye ground” should be very small or negligible. However, with respect to the candidate translation “travel destination” or “trip destination” for the candidate segmentation “ [symbol] ,” each may be found in the target query log as a query in English with a relatively significant query frequency (e.g., total query count of 10 million or average query count per month of 10 thousand). The translation evaluation can provide a subscore or an associated query frequency for each candidate translation to the scoring submodule 430. The scoring module 430 can then evaluates the candidate translations based on the number of occurrence (as represented by the actual or adjusted query frequency) of the each candidate translation in the target query log 160 as a complete query.

The segmentation evaluation submodule 410 determines a respective measure of segmentation quality for each of one or more unique candidate segmentations. As set forth earlier in the specification, this determination can be based at least in part on how many stop words have been removed from the respective sequence of segments of the candidate segmentation and/or a respective frequency of occurrence (e.g., as represented by the actual or adjusted query frequency) for the candidate segmentation in the source language query log 370 as a complete query written in Chinese. The segmentation evaluation module 410 can obtain this data from the segmentation module 320 or directly from the source language query log 370 (e.g., the Chinese language query log).

Continuing with the example of “ [symbol] ”. The candidate segmentation “ [symbol] ” has one stop word (i.e., “ [symbol] ”) removed; the candidate segmentations “ [symbol] ” and “ [symbol] ” have no stop word removed. Thus, the segmentation evaluation submodule 410 can give a smaller base score to the segmentation quality for the candidate segmentation “ [symbol] ” as compared to the other two segmentations. The scoring submodule 430 can use the base scores in evaluating the candidate translations derived from the candidate segmentations.

In addition, the segmentation evaluation module 410 determines the respective frequency of occurrence for the candidate segmentation in the source language query log (e.g., the Chinese query log) as a complete query written in the first language, assuming that segmentation “ [symbol] ,” are more frequently input as a query than the segmentations “ [symbol] ” and “ [symbol] ” in the Chinese language query log, the candidate segmentation “ [symbol] ” can be given a higher boost in segmentation quality score than the candidate segmentations “ [symbol] [symbol] ” and “ [symbol] ”.

In some implementations, the segmentation evaluation submodule 410 may obtain the data for evaluating segmentation quality of the candidate segments from the segmentation module 320. In some implementations, the segmentation evaluation submodule 410 can obtain some of the data directly from the source language query logs 370.

After the translation quality evaluation submodule 420 and the segmentation evaluation module 410 have completed their respective scoring, the scoring submodule 430 can calculate a final score for each candidate translation by combining the subscores produced by the translation evaluation module 420 and the segmentation evaluation module 410. In various implementations, different weights can be associated with the subscores produced by the translation evaluation module 420 and the subscores produced by the segmentation evaluation module 410.

In some implementations, the scoring submodule 330 can determine the score based directly on the frequency of occurrence of the candidate translation in the target language query log 360 as a complete query, the frequency of occurrence of the segmentation associated with the candidate translation in the source language query log 370, and the number of stop words removed from the segmentation. For illustrative purposes, in the aspect of the frequency of occurrence, the candidate translation “travel destination” is found to be associated with the highest query frequency in the target language query log 360 as compared to other candidate translations. At the same time, the candidate segmentation associated with the translation “travel destination”—“ [symbol] ”, has the highest segmentation quality relative to the other two candidate segmentations because it not only has no stop word removed but also is associated with the highest query frequency relative to the other two segmentations in the source language query log 370 as a complete query. Thus, the scoring submodule 430 will assign the candidate translation “travel destination” the highest score. Likewise, the score submodule 330 may assign lower scores to the other candidate translations.

In some implementations, the scoring module 430 derives a final score for each of the candidate translations, and ranks the candidate translations according to their respective final scores. Finally, the refinement module 350 outputs the candidate translation “travel destination” which has the highest final score as a cross-language query suggestion for the primary language query suggestion “ [symbol] .”

In some implementations, the process described above can be repeated for each primary language query suggestion generated by the suggestion module, and a corresponding cross-language query suggestion can be identified for each of the primary language query suggestions. In some implementations, a threshold score can be established, such that if no candidate translation of a primary language query suggestion exceeds the threshold score, then no cross-language query suggestion is provided for the primary language query suggestion. The resulting cross-language query suggestion can be presented to the user via a drop down menu as shown in FIG. 2. In some implementations, the resulting cross-language query suggestions can be presented to the user in other manners (e.g., in a table on the search interface).

By selecting or clicking on a cross-language query suggestion presented in the search interface, such as “travel destination,” the search query “travel destination” is forwarded to the search engine, and the search engine returns search results identified based on the search query “travel destination” to the user.

It should be noted that the above description is only for illustration and a person skilled in the art can make various adaptations and modifications without departing from the scope and spirit of the described techniques. For example, during the course of segmentation, other suitable criteria can be pre-established to better identify the stop words in one or more unique candidate segmentations and reject particular segmentations as candidate segmentations for subsequent translation. In addition, more than one candidate translations may be presented to the users as cross-language query suggestions. In some implementations, a database or index of query suggestion pairs for different source-target language pairs can be established overtime based on the methods described in this specification, so that a simple lookup based on the primary language query suggestion in the database or index can lead to the corresponding secondary language query suggestion.

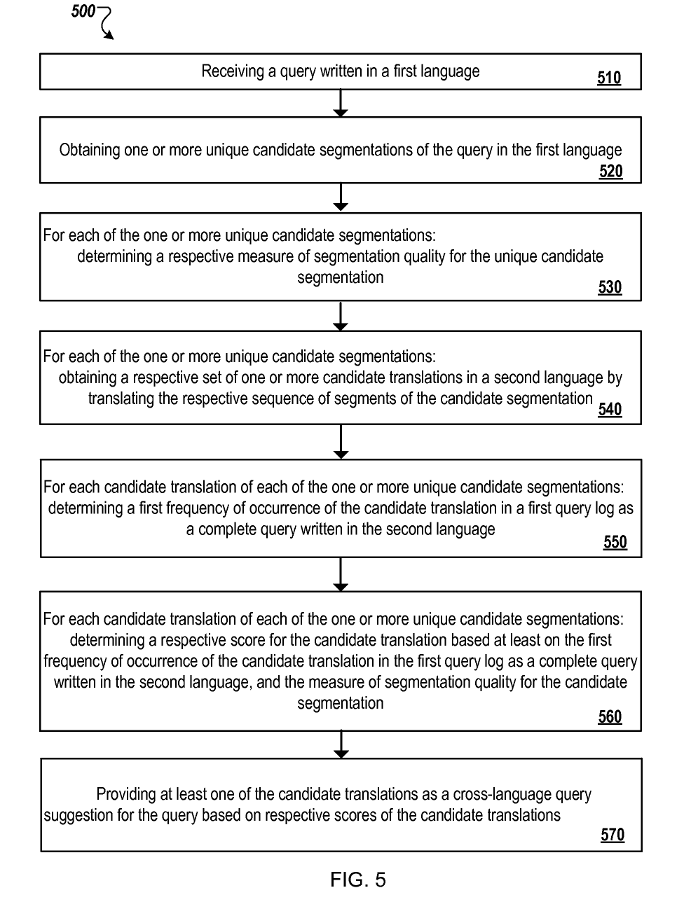

FIG. 5 is a flow diagram illustrating an example process 500 for evaluating candidate translations of a query and providing one of the candidate translations as a cross-language query suggestion based on the evaluation. The example process 500 can be performed by one or more modules of the translation service module 130 shown in FIG. 1, for example.

The process 500 starts when the translation module receives a query written in a first language (510). The query can be a primary language query suggestion generated by the suggestion module in response to the query input entered by a user. Then, the process 500 proceeds to step 520. At step 520, the translation module obtains one or more unique candidate segmentations of the query in the first language (e.g., as implemented by the segmentation module 320 in FIG. 3). Each unique candidate segmentation consists of a respective sequence of segments resulted from segmenting the query in the first language. For each of the one or more unique candidate segmentations, the translation service module, at step 530, determines a respective measure of segmentation quality for the unique candidate segmentation (e.g., as implemented by the segmentation evaluation submodule 410 in FIG. 4). In addition, at step 540, for each of the one or more unique candidate segmentations, the translation service module obtains a respective set of one or more candidate translations in a second language by translating the respective sequence of segments of the candidate segmentation.

Then, for each candidate translation of each of the one or more unique candidate segmentations, the translation service module, at step 550, determines a first frequency of occurrence of the candidate translation in a first query log (e.g., the target language query log) as a complete query written in the second language (e.g., as implemented by the translation evaluation submodule 420). In addition, for each candidate translation of each of the one or more unique candidate segmentations, the translation service module, at step 560, determines a respective score for the candidate translation based at least on the first frequency of occurrence of the candidate translation in the first query log as a complete query written in the second language, and the measure of segmentation quality for the candidate segmentation (e.g., as implemented by the scoring submodule 430 in FIG. 4).

At step 570, the translation service module provides at least one of the candidate translations as a cross-language query suggestion for the query based on respective scores of the candidate translation.

Other features of the above example process and other processes are described in other parts of the specification, e.g., with respect to FIGS. 1-4.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program, also known as a program, software, software application, script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method, comprising:
receiving a query written in a first language, the query being a primary-language query suggestion generated based on a user input submitted to a search engine;
obtaining one or more unique candidate segmentations of the query in the first language, each unique candidate segmentation consisting of a respective sequence of segments resulted from segmenting the query in the first language;
for each of the one or more unique candidate segmentations, determining a respective set of one or more candidate translations in a second language by translating the respective sequence of segments of the candidate segmentation;
for each candidate translation of each of the one or more unique candidate segmentations:
determining a respective segmentation quality for the unique candidate segmentation based at least in part on how many stop words have been removed from the respective sequence of segments of the unique candidate segmentation and a respective first frequency of occurrence of the unique candidate segmentation in a first query log as a complete query written in the first language; and
determining a respective score for the candidate translation based at least on the respective segmentation quality determined for the unique candidate segmentation and a respective second frequency of occurrence of the candidate translation in a second query log as a complete query written in the second language; and
providing at least one of the candidate translations as a cross-language query suggestion for the query based on respective scores of the candidate translations.

2. A computer-implemented method, comprising:
receiving a query written in a first language;
obtaining one or more unique candidate segmentations of the query in the first language, each unique candidate segmentation consisting of a respective sequence of segments resulted from segmenting the query in the first language;
for each of the one or more unique candidate segmentations:
determining a respective measure of segmentation quality for the unique candidate segmentation; and
obtaining a respective set of one or more candidate translations in a second language by translating the respective sequence of segments of the candidate segmentation;
for each candidate translation of each of the one or more unique candidate segmentations:
determining a first frequency of occurrence of the candidate translation in a first query log as a complete query written in the second language; and
determining a respective score for the candidate translation based at least on the first frequency of occurrence of the candidate translation in the first query log as a complete query written in the second language, and the measure of segmentation quality for the candidate segmentation; and
providing at least one of the candidate translations as a cross-language query suggestion for the query based on respective scores of the candidate translations.

3. The computer-implemented method of claim 2, wherein obtaining the one or more unique candidate segmentations of the query in the first language further comprises:
obtaining at least one candidate segmentation that is a partition of the query in the first language.

4. The computer-implemented method of claim 2, wherein obtaining the one or more unique candidate segmentations of the query in the first language further comprises:
obtaining at least one candidate segmentation that has one or more stop words removed from the candidate segmentation.

5. The computer-implemented method of claim 4, wherein, for each of the one or more unique candidate segmentations, determining the respective measure of segmentation quality for the unique candidate segmentation further comprises:
determining the respective measure of segmentation quality based at least in part on how many stop words have been removed from the respective sequence of segments of the candidate segmentation.

6. The method of claim 2, wherein, for each of the one or more unique candidate segmentations, determining the respective measure of segmentation quality for the unique candidate segmentation further comprises:
determining a respective second frequency of occurrence for the candidate segmentation in a second query log as a complete query written in the first language; and
determining the respective measure of segmentation quality based at least in part on the respective second frequency of occurrence of the candidate segmentation in the second query log as a complete query written in the first language.

7. A system, comprising:
one or more processors; and
memory having instructions stored thereon, the instructions, when executed by the one or more processors, cause the one or more processors to perform operations comprising:
receiving a query written in a first language;
obtaining one or more unique candidate segmentations of the query in the first language, each unique candidate segmentation consisting of a respective sequence of segments resulted from segmenting the query in the first language;
for each of the one or more unique candidate segmentations:
determining a respective measure of segmentation quality for the unique candidate segmentation; and
obtaining a respective set of one or more candidate translation in a second language by translating the respective sequence of segments of the candidate segmentation;
for each candidate translation of each of the one or more unique candidate segmentations:
determining a first frequency of occurrence of the candidate translation in a first query log as a complete query written in the second language; and
determining a respective score for the candidate translation based at least on the first frequency of occurrence of the candidate translation in the first query log as a complete query written in the second language, and the
measure of segmentation quality for the candidate segmentation; and
providing at least one of the candidate translations as a cross-language query suggestion for the query based on respective scores of the candidate translations.

8. The system of claim 7, wherein obtaining the one or more unique candidate segmentations of the query in the first language further comprises:
obtaining at least one segmentation that is a partition of the query in the first language.

9. The system of claim 7, wherein obtaining the one or more unique candidate segmentations of the query in the first language further comprises:
obtaining at least one candidate segmentation that has one or more stop words removed from the candidate segmentation.

10. The system of claim 9, wherein, for each of the one or more unique candidate segmentations, determining the respective measure of segmentation quality for the unique candidate segmentation further comprises:
determining the respective measure of segmentation quality based at least in part on how many stop words have been removed from the respective sequence of segments of the candidate segmentation.

11. The system of claim 7, wherein, for each of the one or more unique candidate segmentations, determining the respective measure of segmentation quality for the unique candidate segmentation further comprises:
determining a respective second frequency of occurrence for the candidate segmentation in a second query log as a complete query written in the first language; and
determining the respective measure of segmentation quality based at least in part on the respective second frequency of occurrence of the candidate segmentation in the second query log as a complete query written in the first language.
